(19) United States
(12) Patent Application Publication
(10) Pub. No.: US 2008/0243580 A1
(43) Pub. Date: Oct. 2, 2008

(54) METHOD AND SYSTEM FOR SERVICES PARTNER LABOR RATE OPTIMIZATION

(76) Inventors: Mary E. Helander, North White Plains, NY (US); Walter J. Kozak, Leesburg, VA (US); Hua Ni, Chantilly, VA (US); David E. Nolan, Thornton, CO (US); Paul M. Thompson, Chantilly, VA (US); Leanne K. Viera, Cumming, GA (US)

Correspondence Address: Whitham, Curtis & Christofferson, PC;Suite 340, 11491 Sunset Hills Road, Reston, VA, 20190, US

(21) Appl. No.: 11/691,004

(22) Filed: Mar. 26, 2007

(51) Int. Cl. G06Q 10/00

(52) U.S. Cl. 705/9; 705/400

(57) ABSTRACT

Effective and efficient multi-vendor labor rate negotiations are supported by using a minimization algorithm to provide an optimized total cost of staffing allocation. Critical impact factors are also provided to identify specific labor categories or other vendor attributes that have the greatest impact on the total staffing allocation cost. By varying the elements identified by the critical impact factors and using the computer-implemented optimization algorithm, real-time changes are available to the vendors to assist in the negotiations of services contract agreements.

### BACKGROUND OF THE INVENTION

1. Field of the Invention

The present invention generally relates to the optimization of staffing allocation within a multi-vendor environment and, more particularly, to a computer-implemented method and system that would provide labor rates in order of their significance for the costing and pricing of staffing allocations for potential business partners within the context of providing a bid in response to a Request for Proposal (RFP) and/or other work solicitation vehicles.

2. Background Description

Traditionally, organizational users of hardware and software purchased their information technology, computing resources, and professional services from single sources in order to simplify the maintenance and support of these assets. As technology has advanced, these same user organizations have taken advantage of cost and performance capabilities offered by various manufacturers resulting in a multitude of manufacturers, software providers and other firms having equipment and resources within a user organization. In order to simplify the support and maintenance of these environments, the user organizations have solicited support and maintenance services to be delivered through a large single contract.

These large contracts often require the potential services providers to work with one or more partners who provide resources and/or skills that compliment and coordinate with each other. In agreeing to partner on a proposal or other solicitation for work, vendors may require specific portions of the work. Each partner has hourly labor rates by labor category. The problem is to determine the mix of vendors that will staff all positions in the target work. The partners must negotiate total cost of staffing needed to deliver the solicited work. In addition, pre-negotiated positions and other contract promises must be honored. Partnering agreements and staffing allocations must be determined that compensate for allocation minimums across the various partners. All of these negotiations must be conducted within the framework of a “priced to win” bid for the solicited work. That is, the mix of labor rates and cost of full time equivalents (FTEs) of labor categories must be optimized to ensure that the bid presented to the customer is priced so that the contract is won by the partners.

Traditionally, this negotiation and optimization of price to win is done manually with iterations being calculated on a hit or miss basis. That is, values, such as labor rates, are changed and a new price calculated. However, from this iteration, it cannot be easily discerned which value changes provided the greatest benefit to the final price calculation. The parties involved in the negotiation would have to change all possible values and develop a price using each of the changes. The parties would then manually compare all the new price calculations to determine which changes provided the most benefit. What is missing is the ability to automatically identify the critical cost elements within the bids and to use these critical cost points as a negotiation tool. Once the critical cost factors are identified in terms of which vendors and which job categories have the greatest impact on the price to win, these areas can be targeted for negotiation. Thus, negotiations are streamlined by having detailed quantitative data for the items most influential to the overall bid and not wasting time negotiating changes to areas that have very little impact on the final price to win.

### SUMMARY OF THE INVENTION

It is therefore an exemplary embodiment of the present invention to automatically calculate detailed costs and critical factors that would be used to support the final negotiation process for a services contract bid.

Another exemplary embodiment of the present invention is to provide these costs and critical factors to those negotiating in electronic form so that real-time sensitivity analyses can be conducted.

According to the invention, there is provided a methodology and a system that takes labor rates and other constraints from partner organizations and provides pricing and critical impact factors that are used during negotiations amongst the partners. The pricing is based upon requirements of the target (or solicited) work and must consider any pre-negotiation agreements and constraints between the partners (or vendors). The price information and the critical impacts factors can be provided by the system as a hardcopy table or other form or can be sent electronically to devices (such as but not limited to computer, laptop, storage subsystems, PDAs, any other electronic representation of a rate card and other similar devices). The individuals conducting the negotiation can utilize the critical impact factors to demonstrate changes to the potential bid price in real-time to expedite the negotiation process. The method and system of the invention is intended to optimize the final bid price in order to achieve agreement among the service provider partners. This optimization is twofold in that it provides a method for reaching a price for the bid that is within a competitive range vis-à-vis other teams also bidding for the same contract. In addition, the method and system of the invention optimizes the labor rates that can be used by each of the vendors (or services partners) by reducing and/or changing only those values (e.g., labor rates) that significantly impact the final bid price. The services partners can make targeted changes to specific labor rates rather than across the spectrum of labor categories thus resulting in a maximized return on the cost to deliver.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a simplified flowchart of the overall method.

FIG. 2 is a detailed flowchart of the optimization step of the overall method.

FIG. 3 is a block diagram representation of a business case example using the method.

FIG. 4 is a block diagram of the system level elements for implementing the method.

### DETAILED DESCRIPTION OF THE PREFERRED EMBODIMENTS OF THE INVENTION

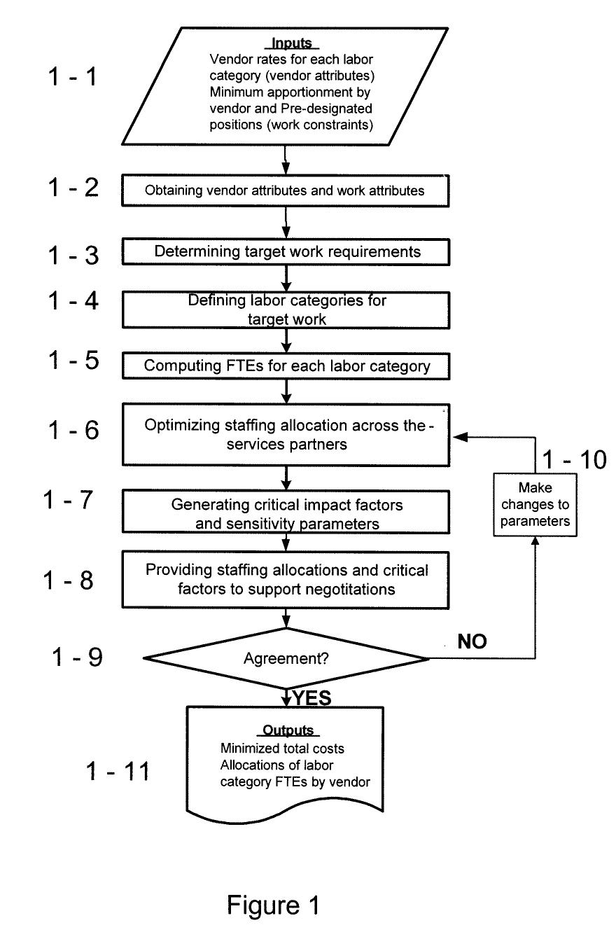

Referring now to the drawings, and more particularly to FIG. 1, there is shown a flowchart depicting the steps of the method for supporting the negotiation of services partners. The method takes cost and constraint information as inputs (1-1) that are provided by the various partners. The cost and constraint information may include but is not limited to the particular labor rates and labor categories for each vendor referred to as the vendor attributes. These vendor attributes may also include information such as but not limited to the skills, availability and experience of the individual resources. Work attributes are also provided as inputs. Work attributes are the constraints in terms of minimum apportionments by vendor as well as but not limited to pre-designated positions by vendor.

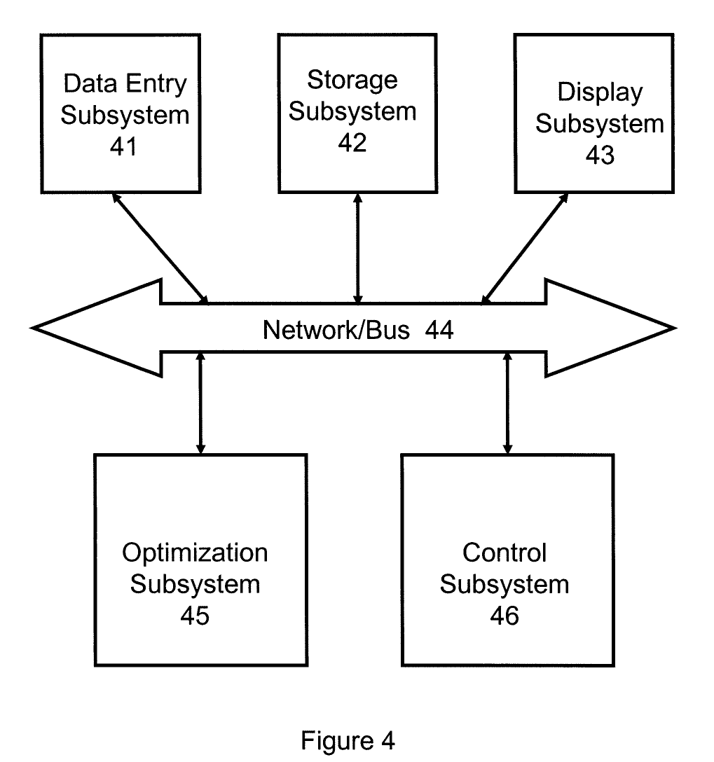

The method obtains the vendor attributes and work attributes at step 1-2. These data can be sent to the lead vendor (aka lead partner) organization electronically or may be entered manually into the system. Details of the data transmission and data entry capabilities are discussed in more detail in FIG. 4. The partners, either individually or collectively determine the requirements of the target work at step 1-3 in terms of work to be delivered and price of work to be delivered. From this, the labor roles and staffing levels are defined at step 1-4. Using these data together with the work attributes and vendor attributes, the Full Time Equivalents (FTEs) are computed for each labor category at step 1-5.

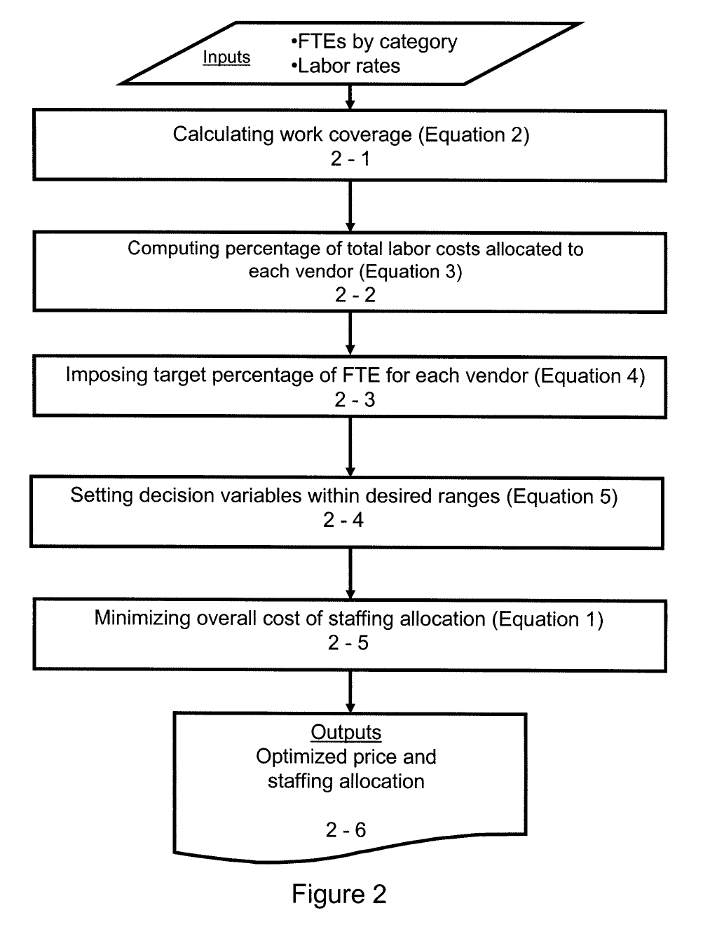

Once the work has been fully specified, the staffing allocation is optimized at step 1-6 by minimizing the following relationship:

$${\sum }_{i = 1}^{N} {\sum }_{j = 1}^{M} {r}_{ij} {x}_{ij} = T \qquad Equation ( 1 )$$

where the variables used in the relationship include:
T as the total cost of the staffing allocation,
N as the number of vendors, indexed i=1, . . . , N or h=1, . . . , N,
M as the number of uniquely rated labor categories, indexed j=1, . . . , M,
rᵢⱼ as the hourly rate for labor category j by vendor i, for i=1, . . . , N and j=1, . . . , M, and
xᵢⱼ as the number of FTEs assigned to labor category j from vendor i, for i=1, . . . , N and j=1, . . . , M.
   Labor rates are applied to the assigned work defined as FTEs across each of the vendors that have a resource or plurality of resources that will be utilized for each of the labor categories. The optimization step (1-5) conforms to the work attributes while adhering to the price to win levels set for the contract and is described in more detail in FIG. 2.

Once the staffing allocation has been optimized at step 1-6, the invention generates critical impact factors and sensitivity parameters at step 1-7. These critical impact factors and sensitivity parameters are generated using sensitivity analysis techniques. A sensitivity analysis is the process of varying model input parameters over a reasonable range (range of uncertainty in values of model parameters) and observing the relative change in model response. If a small change in a parameter results in relatively large changes in the outcomes, the outcomes are said to be sensitive to that parameter. In this sense, the various labor costs and other price factors are analyzed to determine which elements (or factors) have the greatest impact when changed or are most sensitive for the negotiation process.

The optimized staffing allocation and the critical impact factors are used to obtain agreement from the various partners at step 1-9. If agreement is not reached, the critical impact factors are applied and changes are made to the optimization parameters at step 1-10. A new optimized staffing allocation is optimized at step 1-6 and the new minimized total staffing allocation cost is calculated.

For example, the output of step 1-7 may identify that a particular vendor (i.e., vendor A) has a labor rate for a specific labor category (e.g., C++ programmer) that is significant relative to the overall bid due to the number of resources needed for this particular labor category. The services partners could choose to lower the labor rate of vendor A's C++ programmer by some amount. This change would be entered into the optimization method and a new bid price would be calculated. Data entry means are described with respect to FIG. 4. If the new bid price and the particular labor rate for vendor A is acceptable to all the services partners, agreement is reached. If agreement is still not reached, another critical impact factor could be identified and changes to that value could be entered. This method allows single changes or multiple value changes to be entered at step 1-10. Thus, the final price may be reached through numerous iterations and agreements among the various service partners.

Eventually, the partners negotiate an agreement at step 1-9 as to which vendors will perform what work at what labor rate. The method then provides outputs (1-11) as the final minimized total staffing allocation cost which has been negotiated to meet the price to win constraints. In addition, the method can also provide allocation of labor category FTEs by vendor at the negotiated labor rates.

Referring now to FIG. 2, the optimization step (1-6) of FIG. 1 is discussed in more detail. The inputs to step 2-1 of the optimization process include the FTEs by labor category and the labor rates for each of the applicable vendors. These FTEs are provided by vendor only for the work that is assigned to each vendor and not for all the possible labor categories of each vendor. Using the input data, the method calculates the work coverage using the relationship described by equation (2). This step ensures that all the required work identified in step 1-3 of FIG. 1 is assigned to a labor category at a vendor or combination of vendors to ensure all required work is able to be delivered.

$${\sum }_{i = 1}^{N} {x}_{ij} \geq {β}_{j} \\ j = 1 , … , M \qquad Equation ( 2 )$$

wherein, the set of variables of the relationship includes:
N as the number of vendors, indexed i=1, . . . , N or h=1, . . . , N,
M as the number of uniquely rated labor categories, indexed j=1, . . . , M,
βⱼ as the minimum number of full time equivalents (FTEs) required for labor category j for j=1, . . . , M, and
xᵢⱼ as the number of FTEs assigned to labor category j from vendor i, for i=1, . . . , N and j=1, . . . , M.
   In other words, the sum of all the FTEs for each vendor must be greater than or equal to the minimum number of FTEs required to complete the contract as defined by the partners with respect to the work solicitation from the customer.

Once the work is considered to be fully covered, the percentage of labor costs allocated to each vendor is computed at step 2-2 using the relationship:

$$\frac{{\sum }_{j = 1}^{M} {r}_{ij} {x}_{ij}}{{\sum }_{j = 1}^{M} {\sum }_{h = 1}^{N} {r}_{hj} {x}_{hj}} \geq {ρ}_{i} \\ i = 1 , … , N \qquad Equation ( 3 )$$

wherein, the variables of the relationship include:
N as the number of vendors, indexed i=1, . . . , N or h=1, . . . , N,
M as the number of uniquely rated labor categories, indexed j=1, . . . , M,
rᵢⱼ as the hourly rate for labor category j by vendor i, for i=N and j=1, . . . , M,
ρᵢ as the percent of total to be allocated to vendor i, and
xᵢⱼ s the number of FTEs assigned to labor category j from vendor i, for i=1, . . . , N and j=1, . . . , M.

From this, the target percentages of FTEs for each vendor are imposed at step 2-3 using the relationship:

$$\frac{{\sum }_{j = 1}^{M} {x}_{ij}}{{\sum }_{j = 1}^{M} {\sum }_{h = 1}^{N} {x}_{hj}} \geq {ψ}_{i} \\ i = 1 , … , N \qquad Equation ( 4 )$$

where the variable of the relationship include:
N as the number of vendors, indexed i=1, . . . , N or h=1, . . . , N,
M as the number of uniquely rated labor categories, indexed j=1, . . . , M,
ψᵢ as the percent of full time equivalents (FTEs) to be allocated to vendor i, and
xᵢⱼ as the number of FTEs assigned to labor category j from vendor i, for i=1, . . . , N and j=1, . . . , M.

The decision variables are then set within the desired ranges at step 2-4 using the relationship:

lᵢⱼ≦xᵢⱼ≦uᵢⱼ i=1, . . . , N, j=1, . . . , M Equation (5)

where the variables of the relationship include:
N as the number of vendors, indexed i=1, . . . , N or h=1, . . . , N,
M as the number of uniquely rated labor categories, indexed j=1, . . . , M,
xᵢⱼ as the number of FTEs assigned to labor category j from vendor i, for i=1, . . . , N and j=1, . . . , M,
lᵢⱼ as the lower bound for xᵢⱼ, for i=1, . . . , N and j=1, . . . , M, and
uᵢⱼ as the upper bound for xᵢⱼ, for i=1, . . . , N and j=1, . . . , M.

In an ideal situation, these lower and upper boundaries would be 0 and +∞, respectively. However, due to work attributes and other constraints associated with the vendor agreements, the range may have a minimum greater than zero. For example, a vendor has a particularly strong relationship with the customer from other contracts, then the group of vendors may set a minimum level of support from that partner so that there is some level of contact even if the labor rates of that vendor are not the most cost effective.

Finally, the overall cost of the staffing allocation is optimized at step 2-5 using the relationship of Equation (1). This optimization provides as an output (2-6) the optimum cost model for the staffing allocation for each of the labor categories provided by each of the vendors for the target work.

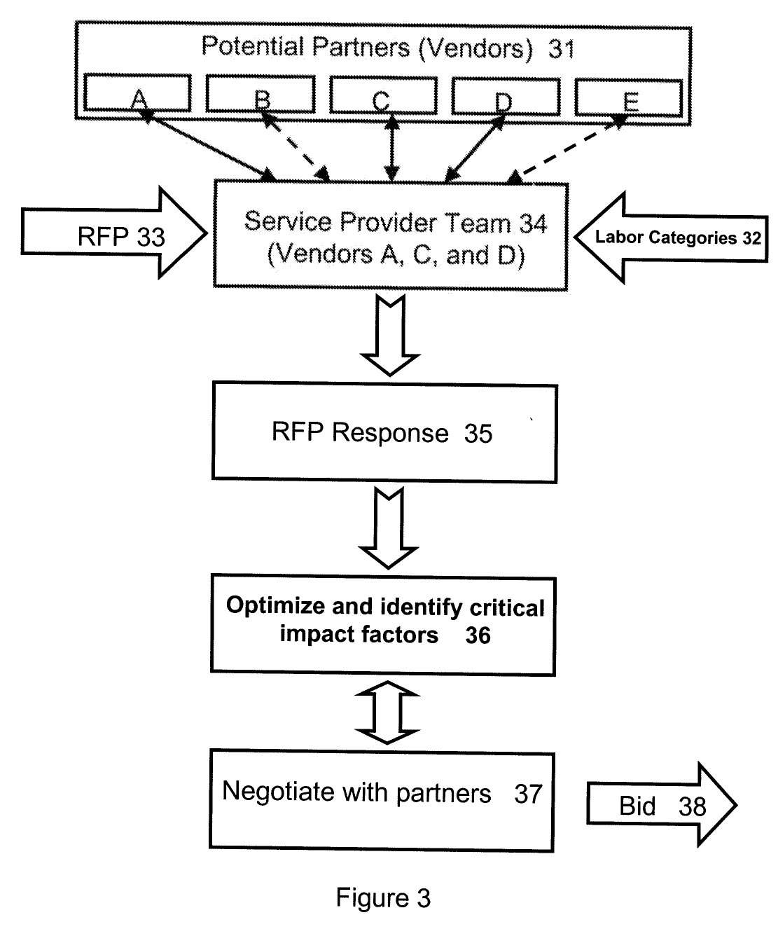

The method of the invention may also be described as a business example as shown in FIG. 3. A group of potential partners (or vendors) 31 shown in FIG. 3 as A, B, C, D, and E have complimentary skills and other vendor attributes such that these vendors may want to partner together to deliver services to customers. When a Request For Proposal (RFP 33) is released by a customer, a vendor or a group of vendors can respond to the RFP 33. Typically, there is a lead vendor who coordinates the response to the RFP 33. The RFP 33 is just one vehicle that is used in the defense and public industries and is not intended to limit the scope of this invention to only those partner negotiations situations that involve an RFP 33. Any number of work solicitation vehicles could be included in this method to include but not be limited to RFP, request for quote (RFQ), etc. Commonly, in a partner environment, one vendor is designated as the lead vendor. This lead position may be based solely on a virtual coin toss or could be based on any number of factors to include but not be limited to the organization with the most number of resources to be allocated or the vendor with the strongest relationship with the customer. Once the RFP 33 is reviewed and the work requirements determined, the lead vendor, in this example vendor D, then selects the service provider team 34 as the subset of vendors from the complete set of potential partners 31 who will be part of the bid response. The selection of these specific vendors to be part of the service provider team 34 can be based on any number of factors to include availability of resources with specific target work skills and strength of previous relationship with lead vendor, and/or strength of relationship with customer, etc.

Once the service provider team 34 has been defined and the labor rates, work attributes, and vendor attributes are identified, the labor categories 32 for the work specified by the RFP 32 are determined. These labor categories by vendor are the first draft of the RFP response 35. That is, the response to the customer will define what work will be performed to meet the requirements of the RFP 33.

Using the particular attributes of each vendor together with the required work defined as labor categories, the invention optimizes the staffing allocation and provides critical impact factors 36. These factors are presented to the service provider team 34 to allow negotiation 37 to be conducted more efficiently and effectively since the elements that cause the greatest impacts on the overall cost of the bid are identified and can be varied as appropriate to meet the price to win objective of the final response. Once the negotiations are completed and the staffing allocation has been agreed, the bid 38 can be completed and provided to the customer.

This method is performed using the computing resources system shown in FIG. 4. The system supports the negotiation of labor rates by optimizing the staffing allocation and making available in real time the changes of total cost when varying the allocation and/or labor rates based on the critical impact factors. The system includes a data entry subsystem 41, a storage subsystem 42, a display subsystem 43, a control subsystem 46, an optimization subsystem 45, and a network/bus 44 subsystem.

The data entry subsystem 31 allows data to be obtained by the control subsystem 46 either from manual entry as with a keyboard of a laptop or desktop computer or similar entry capability of such devices like a personal digital assistant (PDA). The data would either be entered manually, or a command could be entered such that data was transferred to the control subsystem 46 from the storage subsystem 42 or data could be transmitted from outside the device through the network/bus 44. The network/bus 44 may be a bus structure allowing communication among the various subsystems of the invention directly or the network/bus 44 may be a network interface that allows communication between the subsystems through either a wide area or local area network.

The storage subsystem 42 would provide storage for the vendor attributes and work attributes of each of the potential vendors as well as storing the data and associated computation results from the various steps of the method which are performed by the control subsystem 46 and optimization subsystem 45. Thus each of the subsystems could be located within the same physical device as any or all of the other subsystems or could be distributed from the other subsystems and linked through a direct bus or through a network (to include but not limited to local area network as well as wide area network).

The display subsystem 43 could include but not be limited to a presentation screen of the type commonly used with a laptop computer, desktop computer, PDA, cellular phone or other electronic display device. In addition, the display subsystem may include a printing capability such that data could be outputted in paper format.

The control subsystem 46 would provide the computer processing capability to control the other subsystems of the invention. The control subsystem 46 may be a microprocessor based element installed within an existing device such as a PDA or maybe a newly manufactured apparatus which only performs the optimization method or a combination of the two. Control subsystems are commonly used elements whose features should be easily understood by those skilled in the art and is not described in detail.

The optimization subsystem 45 is a microprocessor based element that may be contained within the same physical device with any and/or all of the other subsystems. The optimization subsystem 45 shall be capable of performing the calculations described by equations (1) through (5) and of communicating the results of these calculations with the other subsystems of the invention.

While the invention has been described in terms of its preferred embodiments, those skilled in the art will recognize that the invention can be practiced with modification within the spirit and scope of the appended claims.

Having thus described our invention, what we claim as new and desire to secure by Letters Patent is as follows:

1. A computer-implemented method for optimizing services engagement labor rates to support negotiations with one or more services vendors comprising the steps of:
obtaining one or more of a plurality of inputs wherein at least one or more are selected from vendor attributes, labor rates, labor categories, and labor roles, said one or more of a plurality of inputs being in electronic form from one or more of a plurality of sources wherein at least one or more are selected from databases, data entry devices, local area network interfaces, and wide area networks interfaces;
receiving work allocation constraints from one or more services vendors;
defining labor roles for target work;
computing full time equivalents (FTEs) for each of said labor roles for said target work;
optimizing staffing allocations for said target work based on FTEs computed in said computing step and said vendor attributes and said labor categories from said obtaining step for each of said labor roles for each of said one or more services partners;
generating critical impact factors and sensitivity parameters using sensitivity analyses for said optimized staffing allocations for said target work; and
providing said optimized staffing allocations, said critical impact factors, and said sensitivity parameters to support negotiations with said one or more services partners.

2. The computer-implemented method for optimizing services engagement labor rates to support negotiations with one or more services vendors of claim 1 wherein work allocation constraints include at least:
minimum staffing levels for each of said one or more services vendors; and
pre-designated positions for each of said one or more services vendors.

3. The computer-implemented method for optimizing services engagement labor rates to support negotiations with one or more services vendors of claim 1 wherein said labor roles for said target work are derived from at least:
requirements specified in request for proposal (RFPs);
requirements specified in request for quotes (RFQs);
services offerings of said one or more services vendors; and
teaming agreements and other documents that define services vendor partner relationships.

4. The computer-implemented method for optimizing services engagement labor rates to support negotiations with one or more services vendors of claim 1 wherein said step of optimizing staffing allocation comprises the steps of:
calculating work coverage to ensure all said labor categories and said labor roles required by said target work are addressed;
computing percentages of total labor costs allocated to each of said potential services partners;
imposing target percentages of said FTEs for each of said labor category and said labor roles for said target work;
setting decision variables within desired ranges wherein ranges are defined as lower bounds and upper bounds; and
minimizing overall costs of staffing allocation.

5. The computer-implemented method for optimizing services engagement labor rates to support negotiations with one or more services vendors of claim 4 wherein said step of calculating work coverage comprises a relationship
$${\sum }_{i = 1}^{N} {x}_{ij} \geq {β}_{j}$$
$$j = 1 , … , M$$
wherein, a set of variables of said set of relationship includes:
N as the number of vendors, indexed i=1, . . . , N or h=1, . . . , N,
M as the number of uniquely rated labor categories, indexed j=1, . . . , M,
βⱼ as the minimum number of full time equivalents (FTEs) required for labor category j for j=1, . . . , M,
xᵢⱼ as the number of FTEs assigned to labor category j from vendor i, for i=1, . . . , N and j=1, . . . , M.

6. The computer-implemented method for optimizing services engagement labor rates to support negotiations with one or more services vendors of claim 4 wherein said step of computing said percentages of total labor cost comprises a relationship:
$$\frac{{\sum }_{j = 1}^{M} {r}_{ij} {x}_{ij}}{{\sum }_{j = 1}^{M} {\sum }_{h = 1}^{N} {r}_{hj} {x}_{hj}} \geq {ρ}_{i}$$
$$i = 1 , … , N$$
wherein, a set of variables of said set of relationship includes:
N as the number of vendors, indexed i=1, . . . , N or h=1, . . . , N,
M as the number of uniquely rated labor categories, indexed j=1, . . . , M,
rᵢⱼ as the hourly rate for labor category j by vendor i, for i=N and j=1, . . . , M,
ρᵢ as the percent of total to be allocated to vendor i,
xᵢⱼ as the number of FTEs assigned to labor category j from vendor i, for i=1, . . . , N and j=1, . . . , M.

7. The computer-implemented method for optimizing services engagement labor rates to support negotiations with one or more services vendors of claim 4 wherein said step of imposing target percentages comprises a relationship:
$$\frac{{\sum }_{j = 1}^{M} {x}_{ij}}{{\sum }_{j = 1}^{M} {\sum }_{h = 1}^{N} {x}_{hj}} \geq {ψ}_{i}$$
$$i = 1 , … , N$$
wherein, a set of variables of said set of relationship includes:
N as the number of vendors, indexed i=1, . . . , N or h=1, . . . , N,
M as the number of uniquely rated labor categories, indexed j=1, . . . , M,
ψᵢ as the percent of full time equivalents (FTEs) to be allocated to vendor i,
xᵢⱼ as the number of FTEs assigned to labor category j from vendor i, for i=1, . . . , N and j=1, . . . , M.

8. The computer-implemented method for optimizing services engagement labor rates to support negotiations with one or more services vendors of claim 4 wherein said step of setting decision variables comprises a relationship:
lᵢⱼ≦xᵢⱼ≦uᵢⱼ i=1, . . . , N, j=1, . . . , M
wherein, a set of variables of said set of relationship includes:
N as the number of vendors, indexed i=1, . . . , N or h=1, . . . , N,
M as the number of uniquely rated labor categories, indexed j=1, . . . , M,
xᵢⱼ as the number of FTEs assigned to labor category j from vendor i, for i=1, . . . , N and j=1, . . . , M,
lᵢⱼ as the lower bound for xᵢⱼ, for i=1, . . . , N and j=1, . . . , M,
uᵢⱼ is the upper bound for xᵢⱼ, for i=1, . . . , N and j=1, . . . , M.

9. The computer-implemented method for optimizing services engagement labor rates to support negotiations with one or more services vendors of claim 4 wherein said step of minimizing staffing allocation costs comprises a relationship:
$${\sum }_{i = 1}^{N} {\sum }_{j = 1}^{M} {r}_{ij} {x}_{ij} = T$$
wherein, a set of variables of said set of relationship includes:
T as the total cost of said staffing allocation,
N as the number of vendors, indexed i=1, . . . , N or h=1, . . . , N,
M as the number of uniquely rated labor categories, indexed j=1, . . . , M,
rᵢⱼ as the hourly rate for labor category j by vendor i, for i=1, . . . , N and j=1, . . . , M,
xᵢⱼ as the number of FTEs assigned to labor category j from vendor i, for i=1, . . . , N and j=1, . . . , M.

10. The computer-implemented method for optimizing services engagement labor rates to support negotiations with one or more services vendors of claim 1 wherein said generating step performs sensitivity analyses to evaluate changes to said one or more of said plurality of inputs.

11. A machine readable medium containing instructions for performing a method for optimizing services engagement labor rates to support negotiations with one or more services vendors comprising the steps of:
receiving work allocation constraints for one or more services vendors;
defining labor roles for target work;
computing full time equivalents (FTEs) for each of said labor roles for said target work optimizing staffing allocations for each of said labor roles for each of said one or more services vendors;
generating critical impact factors for said optimized staffing allocations; and
providing said optimized staffing allocations and critical impact factors to support negotiations with said one or more services partners.

12. The machine readable medium containing instructions for said method for optimizing services engagement labor rates to support negotiations with one or more services vendors of claim 11 wherein work allocation constraints include at least:
minimum staffing levels for each of said one or more services vendors; and
pre-designated positions for each of said one or more services vendors.

13. The machine readable medium containing instructions for performing said method for optimizing services engagement labor rates to support negotiations with one or more services vendors of claim 11 wherein said labor roles for said target work are derived from at least:
requirements specified in request for proposal (RFPs);
requirements specified in request for quotes (RFQs); and
services offerings of said potential services partners.

14. The machine readable medium containing instructions for performing said method for optimizing services engagement labor rates to support negotiations with one or more services vendors of claim 11 wherein said step of optimizing staffing allocation comprises the steps of:
calculating work coverage to ensure all said labor categories and said labor roles required by said target work are addressed;
computing percentages of total labor costs allocated to each of said one or more services vendors;
imposing target percentages of said FTEs for each of said labor category and said labor roles for said target work;
setting decision variables within desired ranges wherein ranges are defined as lower bounds and upper bounds; and
minimizing overall costs of staffing allocation.

15. The machine readable medium containing instructions for performing said method for optimizing services engagement labor rates to support negotiations with one or more services vendors of claim 14 wherein said step of calculating work coverage comprises a relationship
$${\sum }_{i = 1}^{N} {x}_{ij} \geq {β}_{j}$$
$$j = 1 , … , M$$
wherein, a set of variables of said set of relationship includes:
N as the number of vendors, indexed i=1, . . . , N or h=1, . . . , N,
M as the number of uniquely rated labor categories, indexed j=1, . . . , M,
βⱼ as the minimum number of full time equivalents (FTEs) required for labor category j for j=1, . . . , M,
xᵢⱼ as the number of FTEs assigned to labor category j from vendor i, for i=1, . . . , N and j=1, . . . , M.

16. The machine readable medium containing instructions for performing said method for optimizing services engagement labor rates to support negotiations with one or more services vendors of claim 14 wherein said step of computing said percentages of total labor cost comprises a relationship:
$$\frac{{\sum }_{j = 1}^{M} {r}_{ij} {x}_{ij}}{{\sum }_{j = 1}^{M} {\sum }_{h = 1}^{N} {r}_{hj} {x}_{hj}} \geq {ρ}_{i}$$
$$i = 1 , … , N$$
wherein, a set of variables of said set of relationship includes:
N as the number of vendors, indexed i=1, . . . , N or h=1, . . . , N,
M as the number of uniquely rated labor categories, indexed j=1, . . . , M,
rᵢⱼ as the hourly rate for labor category j by vendor i, for i=1, . . . , N and j=1, . . . , M,
ρᵢ as the percent of total to be allocated to vendor i,
xᵢⱼ as the number of FTEs assigned to labor category j from vendor i, for i=1, . . . , N and j=1, . . . , M.

17. The machine readable medium containing instructions for performing said method for optimizing services engagement labor rates to support negotiations with one or more services vendors of claim 14 wherein said step of imposing target percentages comprises a relationship:
$$\frac{{\sum }_{j = 1}^{M} {x}_{ij}}{{\sum }_{j = 1}^{M} {\sum }_{h = 1}^{N} {x}_{hj}} \geq {ψ}_{i}$$
$$i = 1 , … , N$$
wherein, a set of variables of said set of relationship includes:
N as the number of vendors, indexed i=1, . . . , N or h=1, . . . , N,
M as the number of uniquely rated labor categories, indexed j=1, . . . , M,
ψᵢ as the percent of full time equivalents (FTEs) to be allocated to vendor i,
xᵢⱼ as the number of FTEs assigned to labor category j from vendor i, for i=1, . . . , N and j=1, . . . , M.

18. The machine readable medium containing instructions for performing said method for optimizing services engagement labor rates to support negotiations with one or more services vendors of claim 14 wherein said step of setting decision variables comprises a relationship:
lᵢⱼ≦xᵢⱼ≦uᵢⱼ i−1, . . . , N, j=1, . . . , M
wherein, a set of variables of said set of relationship includes:
N as the number of vendors, indexed i=1, . . . , N or h=1, . . . , N,
M as the number of uniquely rated labor categories, indexed j=1, . . . , M,
xᵢⱼ as the number of FTEs assigned to labor category j from vendor i, for i=1, . . . , N and j=1, . . . , M,
lᵢⱼ as the lower bound for xij, for i=1, . . . , N and j=1, . . . , M,
uᵢⱼ as the upper bound for xij, for i=1, . . . , N and j=1, . . . , M.

19. The machine readable medium containing instructions for performing said method for optimizing services engagement labor rates to support negotiations with one or more services vendors of claim 14 wherein said step of minimizing overall staffing allocation costs comprises a relationship:
$${\sum }_{i = 1}^{N} {\sum }_{j = 1}^{M} {r}_{ij} {x}_{ij} = T$$
wherein, a set of variables of said set of relationship includes:
T as the total cost of said staffing allocation,
N as the number of vendors, indexed i=1, . . . , N or h=1, . . . , N,
M as the number of uniquely rated labor categories, indexed j=1, . . . , M,
rᵢⱼ as the hourly rate for labor category j by vendor i, for i=1, . . . , N and j=1, . . . , M,
xᵢⱼ as the number of FTEs assigned to labor category j from vendor i, for i=1, . . . , N and j=1, . . . , M.

20. A computing resources system for performing a method for optimizing services engagement labor rates to support negotiations with one or more services vendors comprising:
a controller subsystem;
a data entry subsystem;
a network/bus subsystem;
a storage subsystem;
a display subsystem; and
an optimization subsystem which provides a minimized total staffing allocation cost using a relationship:
$${\sum }_{i = 1}^{N} {\sum }_{j = 1}^{M} {r}_{ij} {x}_{ij} = T$$
wherein, a set of variables of said set of relationship includes:
T as the total cost of said staffing allocation,
N as the number of vendors, indexed i=1, . . . , N or h=1, . . . , N,
M as the number of uniquely rated labor categories, indexed j=1, . . . , M,
rᵢⱼ as the hourly rate for labor category j by vendor i, for i=1, . . . , N and j=1, . . . , M,
xᵢⱼ as the number of FTEs assigned to labor category j from vendor i, for i=1, . . . , N and j=1, . . . , M.
